(19) United States
(12) Patent Application Publication
(10) Pub. No.: US 2020/0143367 A1
(43) Pub. Date: May 7, 2020

(54) DECENTRALIZED DIGITAL CONTENT DISTRIBUTION SYSTEM AND PROCESS USING BLOCK CHAINS

(71) Applicant: CODEX LLC, San Juan, PR (US)

(72) Inventors: Zachary James LeBeau, New York, NY (US); Milad Mostavi, Bucharest (RO)

(73) Assignee: CODEX LLC, San Juan, PR (US)

(21) Appl. No.: 16/679,429

(22) Filed: Nov. 11, 2019

Related U.S. Application Data
(63) Continuation of application No. PCT/US2018/033340, filed on May 18, 2018.
(60) Provisional application No. 62/508,008, filed on May 18, 2017.

(51) Int. Cl. G06Q 20/38; H04L 9/32

(52) U.S. Cl. CPC G06Q 20/389; H04L 9/3236; H04L 9/3297; H04L 9/3252; H04L 9/3271; G06Q 2220/00; G06Q 20/3827; G06F 2221/2141; H04L 2209/38; H04L 2209/56; H04L 2209/603; G06Q 20/3829

(57) ABSTRACT

A method and system for registering digital content with a decentralized distribution system having a front end computing system, the front end computing system including a front end processor, a display, a user interface, and front end memory, the decentralized distribution system having a back end computing system communicatively connected to the front end computing system, the back end computing system including a back end processor and back end memory: communicate, in response to a user's interactions with the user interface of the front end computing system, digital content related information to the back end computing system, the digital content related information corresponding to the user's interactions with the user interface of the front end computing system; register, with the back end computing system, digital content based upon the received digital content related information; and create electronic tokens related to the registered digital content, using the back end computing system, in response to information communicated to the back end computing system, the communicated information corresponding to the user's interactions with the user interface of the front end computing system.

### PRIORITY INFORMATION

The present application is a continuation application of PCT Patent Application Number PCT/US2018/033340, filed on May 18, 2018, and claims priority, under 35 U.S.C. § 120, from PCT Patent Application Number PCT/US2018/033340, filed on May 18, 2018. The entire content of PCT Patent Application Number PCT/US2018/033340, filed on May 18, 2018, is hereby incorporated by reference.

PCT Patent Application Number PCT/US2018/033340, filed on May 18, 2018, claims priority, under 35 U.S.C. § 119(e), U.S. Provisional Patent Application, Ser. No. 62/508,008, filed on May 18, 2017. The entire content of U.S. Provisional Patent Application, Ser. No. 62/508,008, filed on May 18, 2017, is hereby incorporated by reference.

### COPYRIGHT NOTICE

A portion of the disclosure of this patent application/document contains material (program code and/or pseudocode) which is subject to copyright protection. The copyright owner(s) has/have no objection to the facsimile reproduction by anyone of the patent document or patent disclosure, as it appears in the Patent and Trademark Office patent file or records, but otherwise, the copyright owner(s) reserve(s) all copyright rights.

### BACKGROUND

Digital media has opened many avenues for creativity and expression; however, digital media presents issues with respect to securing of profit from the distribution (sale) of the digital media (creative work) or the exercising of control over the distribution of digital media (creative work).

Early forms of distribution of digital media included files written to electronic media, such as floppy disks, CDs and DVDs. These early forms of distribution of digital media presented issues in that the distribution relied upon a tangible static medium to physically contain the digital media so as to convey the digital media.

To overcome the reliance on a tangible static medium, digital media began to be distributed as electronic files over the Internet or other communication systems.

For example, digital files containing music (digital media) could be conveyed to a customer, over the internet, after the purchase thereof from a website, such as iTunes™. A copy of the digital file containing the desired music would be transmitted from the website to the customer's personal computing device, such as a laptop, computer, tablet, personal digital assistant, smart phone, electronic audio player, etc. Thereafter, the customer would be able to listen to the music.

Although allowing a copy of the digital file (digital media) to be transmitted to a customer overcomes the reliance on a tangible static medium, it presents other problems such as piracy, wherein piracy is the copying or distribution of electronic digital media without paying the fees required by the publishers and/or distributors.

For example, the ability to copy files reduces costs so low that theft and illicit distribution are virtually free and leave little, if any evidence of the theft.

One solution to this piracy problem has been to equip files with electronic digital rights management systems to restrict the uses of the digital media.

Digital rights management systems have proven to be unpopular with end users because of all the restrictions or constraints, making sharing or even backing up the files difficult or impossible. The complaints of the end users have caused some producers of digital media to use the absence of digital rights restrictions on the digital media as a selling point.

On the other hand, another solution to the piracy problem has driven a great deal of creative content to reside in centralized platforms such as iTunes™, Netflix™ and Amazon Kindle™.

These centralized platforms further centralize control over the digital media (creative work) into the hands of publishers, producers, and distributors rather than the artists (creators of the digital media) and reduces the “profits” realized by the artists.

Artists (creators) do not favor the centralization and control of their material because the artists have not necessarily benefitted from such controls, despite the breadth and immediacy of streaming options for distribution.

More specifically, when an artist turns over control of their work to another entity, who has access to marketing and distribution channels, it is this non-artist entity who reap the lion's share of the benefit, not the creator of the digital media.

To address the centralized control issue, the distribution connections or channels should be effectively controlled by the artist or digital media creator. As with the conventional digital distribution channels, the Internet provides a communication platform to enable a system that places the necessary distribution connections or channels in the effective control of the artist or digital media creator. However, a communication platform is not enough to address specific distribution issues, security issues, etc.

FIG. 1 illustrates a conventional system managing the distribution of digital media content. As illustrated in FIG. 1, a computing environment manages media. The computing environment includes a content management system 110, which provides an application programming interface service 115 to access various different media management functions provided by the content management system 110.

The online host media site 140 contains a JavaScript™ module 145 that facilitate communicating over the network 125 to access and retrieve certain information associated with the uploaded content, such as rights information, ownership information, licensing or purchasing information, unique identifiers, provenance information, and so on. The content management system 110 stores such information in various databases or memory.

The database 120 includes content information 122 associated with digital content items, such as information describing the digital content items, information representing the content items, metadata associated with the digital content items, and so on. The database 120 also include contract data or information 124 associated with rights assigned to the digital content items and/or use of the digital content items, and one or more public ledgers 126, such as block chains associated with the digital content items that track transactions performed with respect to the digital content items.

The content management system 110 includes various components that perform digital currency transactions in order to establish the transfer of rights of digital content between entities and various components that generate, create, update, or otherwise maintain public ledgers of the performed transactions.

For example, the content management system 110 includes a content registration module, a transaction module, a public ledger module, and a contract module.

The content registration module is configured and/or programmed to register digital content items received from owners of the digital content items.

The transaction module is configured and/or programmed to perform bitcoin or other digital currency transactions to generate public ledger entries that represent rights transfers of the digital content items between providers and recipients.

The public ledger module is configured and/or programmed to maintain a public ledger of the generated public ledger entries for the registered digital content items.

The contract module is configured and/or programmed to maintain contracts for registered digital content items.

The content management system manages the rights to registered digital content with the public ledger module, which generates a block chain of transaction entries for digital content, wherein each of the transaction entries represents a transfer of a right to digital content from a provider of the digital content to a recipient of the digital content, and the transaction module, which performs transactions to transfers rights of the digital content from providers to recipients, wherein the performed transactions include transfers of digital currency between bitcoin (or other digital currency) addresses associated with the providers of the digital content and bitcoin (or other digital currency) addresses associated with the recipients of the rights to the digit content.

It is noted that a bitcoin is a distributed crypto-currency or a decentralized digital currency. Bitcoin uses cryptography to control the creation and transfer of money; enables instant payments to anyone, anywhere in the world; and uses peer-to-peer technology to operate with no central authority.

Bitcoin is an open source software application and a shared protocol, which allows users to pseudo-anonymously and instantaneously transact, using a digital currency, without needing to trust counterparties or separate intermediaries by utilizing public/private key pairs, a popular encryption technique.

A cryptographically secure decentralized peer-to-peer electronic payment system enables transactions involving virtual currency in the form of digital tokens. One exemplary function of the many functions that a digital token may provide is providing a crypto-currency function whose implementation relies on cryptography to generate the digital tokens as well as validate related transactions.

The cryptographically secure decentralized peer-to-peer electronic payment system prevents counterfeiting and double-spending problems without any centralized authority by using a public digital ledger accessible to all network nodes in which all cryptographically secure decentralized peer-to-peer electronic payment system's balances and transactions are announced, agreed upon, and recorded. The transactions are time-stamped by hashing the transaction into an ongoing chain of hashed digital signatures based upon asymmetric or public key cryptography forming a record that cannot be changed without redoing the entire chain.

Other examples of conventional system managing the distribution of digital media content using block chain technology are described in Published US Patent Application Number 2016/0321675; Published US Patent Application Number 2016/0321676; Published US Patent Application Number 2016/0321769; and Published US Patent Application Number 2016/0323109.

The entire contents of Published US Patent Application Number 2016/0321675; Published US Patent Application Number 2016/0321676; Published US Patent Application Number 2016/0321769; and Published US Patent Application Number 2016/0323109 are hereby incorporated by reference.

Other examples of system for managing the distribution of digital media content are described in U.S. Pat. Nos. 7,895,349; 9,608,829; Published US Patent Application Number 2005/0138081; Published US Patent Application Number 2010/0138508; Published US Patent Application Number 2015/0026072; Published US Patent Application Number 2015/0332283; Published US Patent Application Number 2016/0085955; Published US Patent Application Number 2017/0091756; Published US Patent Application Number 2017/0103468; and Published US Patent Application Number 2017/0109748.

The entire contents of U.S. Pat. Nos. 7,895,349; 9,608,829; Published US Patent Application Number 2005/0138081; Published US Patent Application Number 2010/0138508; Published US Patent Application Number 2015/0026072; Published US Patent Application Number 2015/0332283; Published US Patent Application Number 2016/0085955; Published US Patent Application Number 2017/0091756; Published US Patent Application Number 2017/0103468; and Published US Patent Application Number 2017/0109748 are hereby incorporated by reference.

Notwithstanding the various conventional examples described above, these conventional processes and systems fail to adequately provide the artist or creator of the digital media a system that effectively puts control of the distribution of the digital media in the control of the artist/creator as well as provide an effective distribution system that maximizes exposure of the digital media to entities that are interested in acquiring or utilizing the digital media.

Therefore, it is desirable to provide a system which provides an efficient and effective distribution platform to maximize exposure of the digital media to entities that are interested in acquiring or utilizing the digital media.

Moreover, it is desirable to provide a system which provides an efficient and effective distribution platform that is decentralized and is effectively controlled by the artist/creator of the digital media.

In addition, it is desirable to provide a system which provides an efficient and effective distribution platform that does not require a specialized set of skills to utilize.

It is further desirable to provide a system which provides an efficient and effective decentralized distribution platform that maximizes exposure of the digital media to entities that are interested in acquiring or utilizing the digital media while being effectively controlled by the artist/creator of the digital media and having an interface that is easy to use and highly efficient.

### BRIEF DESCRIPTION OF THE DRAWINGS

The drawings are only for purposes of illustrating various embodiments and are not to be construed as limiting, wherein:

FIG. 1 is a block diagram illustrating a conventional computing environment for performing transactions associated with digital content;

FIG. 2 illustrates a block diagram of a decentralized distribution system for digital media;

FIG. 3 is an overview of the general architecture of a platform for the decentralized distribution system for digital media of FIG. 2;

FIG. 4 is a block diagram illustrating a process for authenticating a wallet holder in the decentralized distribution system for digital media;

FIG. 5 is a block diagram illustrating a process for creating a project in the decentralized distribution system for digital media;

FIG. 6 is a block diagram illustrating a process for launching a created token on the decentralized distribution system for digital media;

FIG. 7 is a flowchart illustrating a process for funding a created token on the decentralized distribution system for digital media;

FIG. 8 is a block diagram illustrating a process for content distribution on the decentralized distribution system for digital media; and

FIG. 9 through FIG. 27 illustrate interfaces for the decentralized distribution system for digital media.

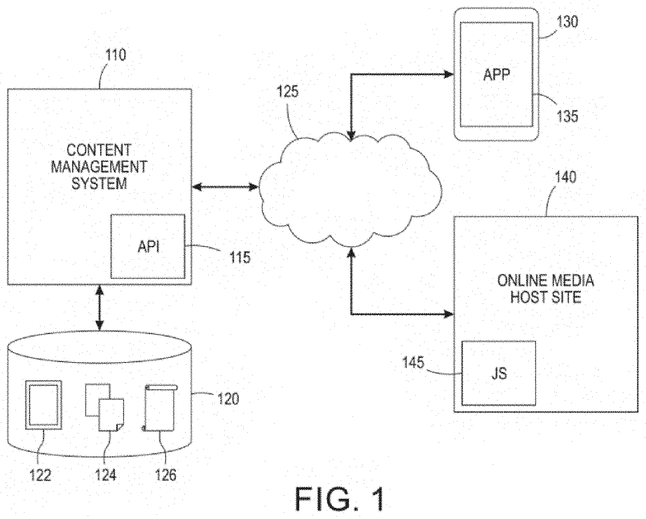

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

The use and distribution of digital content, such as digital documents, images, multimedia, and so on, has historically been difficult to track, control and/or protect by owners of the digital content, especially online.

For example, social networks, messaging, micro-blogs, and so on, provide easy mechanisms for users to view, share, and appropriate content provided by others. Content creators and owners, therefore, often face problems when attempting to assert the ownership of their works and, in some cases, license or receive remuneration for the use of their works by others.

A system and method for managing media, such as digital content, using block chain technology are described below. The system and method provide block chain-based attribution and authentication to creators of media and other digital content.

For example, the system and method may provide decentralized distribution channels for digital content, such as social media networks and other networks; smart contract execution environments for regulating usage and payments of fees and royalties for use of digital content; and block chain based media usage metering, rights transactions, and payment services.

The decentralized distribution system for digital media, described below, is a multi-layered system that allows flexibility in funding, monetizing, and distributing digital media, such as entertainment products (movies, TV shows, e-books, e-literature, digitalized photos, digitalized artwork, music, etc.) or any intellectual property that can be digitized.

In one embodiment, decentralized distribution system for digital media generally has four modules or subsystems, each of which is a distinct system onto itself.

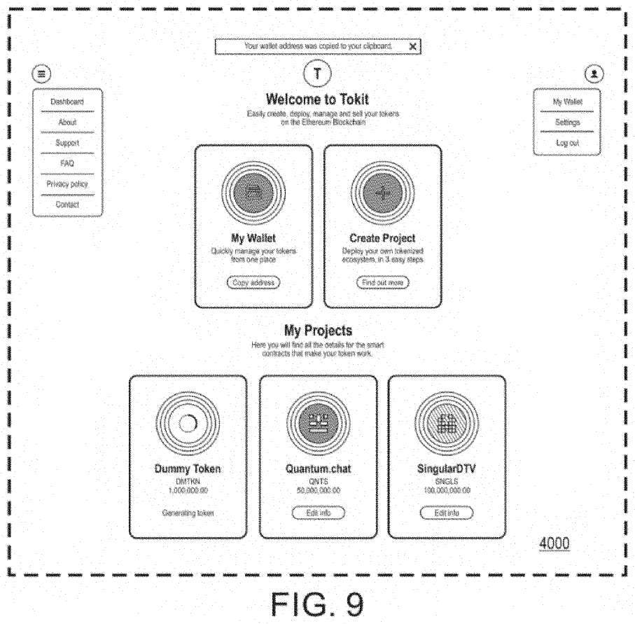

The first module or subsystem of the decentralized distribution system for digital media is the front end or user interface, wherein an example of such an interface is illustrated by FIG. 9 through FIG. 26 and described below. The front end or user interface may be a web-based system that allows users (artist/creators) to create projects and manage their rights, revenue, royalties, and rewards.

The front end or user interface may also be a more distributed system, similar to a cryptocurrency wallet.

The second module or subsystem of the decentralized distribution system for digital media is a token system. The tokens or cryptotokens used in the decentralized distribution system for digital media are roughly equivalent to a cryptocurrency such as Bitcoin or Ether but with specific utility programmed therein.

In the decentralized distribution system for digital media, the tokens are unique to the project for which the tokens are created rather than being a general use currency because the tokens are programmed with a specific set of functions and utility.

When a project issues tokens to the general public, the tokens can be acquired in exchange for Ether or other form of cryptocurrency, wherein the tokens signify participation in the project and in any possible rewards associated therewith.

The third module or subsystem of the decentralized distribution system for digital media is a smart contract system, wherein smart contracts are generated, updated, and managed. The smart contracts are ordered together to administer a range of functions and in doing so are called smart contract systems.

The decisions users make and communicate through the front-end or user interface about distribution terms including pricing, rights, revenue, royalty allocation, and fund-raising are all reflected in the smart contract system. By reflecting the distribution terms in the smart contract system, the terms can therefore be defined once, and the rest is automated.

The fourth module or subsystem of the decentralized distribution system for digital media is a block chain, such as an Ethereum block chain, that records the smart contracts and executes the smart contracts in a secure, distributed environment.

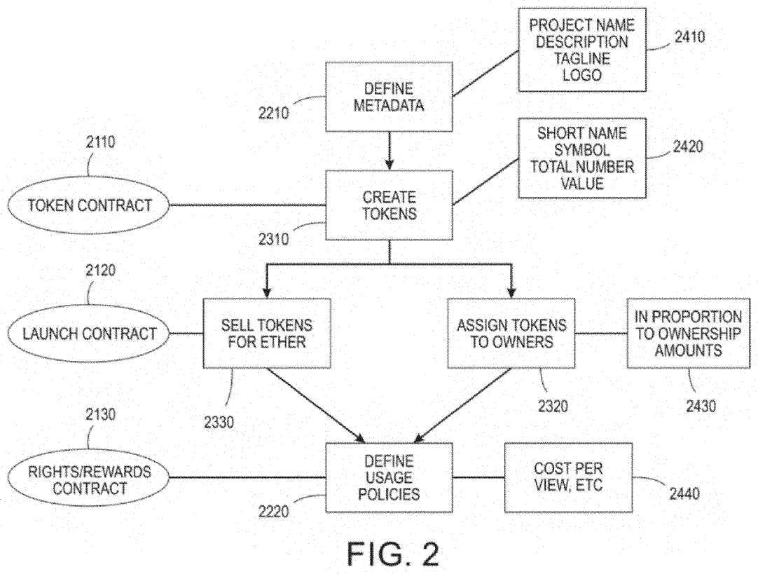

FIG. 2 illustrates a block diagram of the decentralized distribution system for digital media discussed above. As illustrated in FIG. 2, a user (artist/creator) creates, through the user interface, a project; names the project; and may provide a description thereof and/or a logo (image), at block 2410. This information is stored or defined in a metadata file, at block 2210.

After a project is created, the metadata file is utilized in creating tokens for the created project, at block 2310. The created tokens (or cryptotokens) store value and utility internal to a project. At block 2420, the user may give the token(s) a name and a short symbol that can be used to look it up. At this point, the project creators (owners) also choose how many tokens to issue and the expected value of tokens.

The tokens are governed by a token contract (smart contract), at block 2110. The token contract will be discussed in more detail below.

At block 2320, the tokens, through the user interface, can be assigned. For example, as provided for in block 2430, the tokens can be assigned proportionally to ownership amounts.

In another scenario, the tokens can be assigned to the owners or producers of the project and to others proportional to their involvement in the project. In this scenario, the assignment of tokens is substantially the same as assigning rights. Since the tokens represent the intellectual property of a project and the terms and conditions thereof, the tokens may represent the rights, revenue, royalty, and rewards flow as well.

In another scenario, tokens may only represent an access to “consume” the representative digital content or intellectual property right. In other words, tokens may be representative of the use, consummation and/or participation in and/or from of the intellectual properties of a project.

For any unassigned tokens, these tokens can be “sold” for Ether or other digital currency. This release of a proportion of the tokens for public “sale” allows members of the general public to demonstrate an interest in a project and potentially share in its success.

The selling of the unassigned tokens are governed by a launch contract (smart contract), at block 2120. The launch contract will be discussed in more detail below.

At block 2220, usage policies, such as the terms under which others can interact with the project, are defined by the user at block 2440, through the user interface. For example, if the project is a movie, interaction would be watching the movie and the cost associated therewith. Other forms of interaction might be possible, such as downloading, reusing, or broadcasting the content.

The usage policies are governed by a rights/reward contract (smart contract), at block 2130. The rights/reward contract will be discussed in more detail below.

Previously configured items can also be edited at block 2220 because the usage terms may not be defined until very late in the process, after a film or music video (for example) is complete or nearly so. Other actions, such as issuing tokens, take place much earlier in the project life cycle, especially if tokens are being used to raise the funds needed to complete the project.

As noted above, the tokens and terms of the project are governed by smart contracts.

The token contract is a smart contract that acts as the token ledger. Within the token contract, the amount of tokens each address holds is internally stored, and through the token contract's different functions, tokens can be transferred from one address to another. Since the token contract is a block chain based system, the addresses of the token contract belong to some entity, such as a person or a company. The block chain records the ownership and the amounts of ownership (as established above). In this embodiment, the tokens relate to funds distribution.

The launch contract is created when tokens are put up for consumption by the public or private parties. When all the tokens associated with a project are pre-allocated, there is no need for a launch campaign to raise more funds.

The launch contract is assigned the tokens created for the fund raising campaign for the project. In the event that a launch of tokens takes place, Ether or other digital currency sent to the launch contract will trigger a return of project tokens of equal value. After the launch of these tokens is complete, the Ether or other digital currency collected will be sent to the configured beneficiary address (usually the token creator, unless otherwise specified during the creation) if the launch met its fundraising goal.

The rights/reward contract mediates rights, revenue, royalty, and reward acquisition and sharing. Ether or other digital currency can be deposited by any external address.

The deposits may include the proceeds from the sale of tokens, which go directly to the project creator so as to be used to build or create the project. The deposits may also include the proceeds from donations from people sympathetic to a particular project, which may go directly to the project creator so as to be used to build or create the project. In addition, the deposits may also include the proceeds from payments for the use of the project's result (i.e., displaying a movie), wherein the token holders can withdraw funds associated with the use driven payments in accordance with the rights/reward contract and in proportion to the amount of tokens they hold.

As noted above, the decentralized distribution system for digital media is a multi-layered system that allows flexibility and decentralization in funding, monetizing, and distributing entertainment products such as movies, TV shows, e-books, e-literature, digitalized photos, digitalized artwork, and music—any piece of entertainment or intellectual property that can be digitized in a decentralized way, using block chain technology.

The decentralized distribution system provides functionality through various different interconnected modules, that provide wallet management; user authentication; project creation; a smart contract system deployment for each project (for example an Ethereum smart contract system); rights management mechanisms; on-chain (block chain) payment processing; on-chain (block chain) token (project) registry; token launch tools; peer to peer (video and/or audio) content distribution; channel registry for the peer to peer (video and/or audio) content distribution; and application of usage policies to content consumed through the peer to peer (video and/or audio) content distribution.

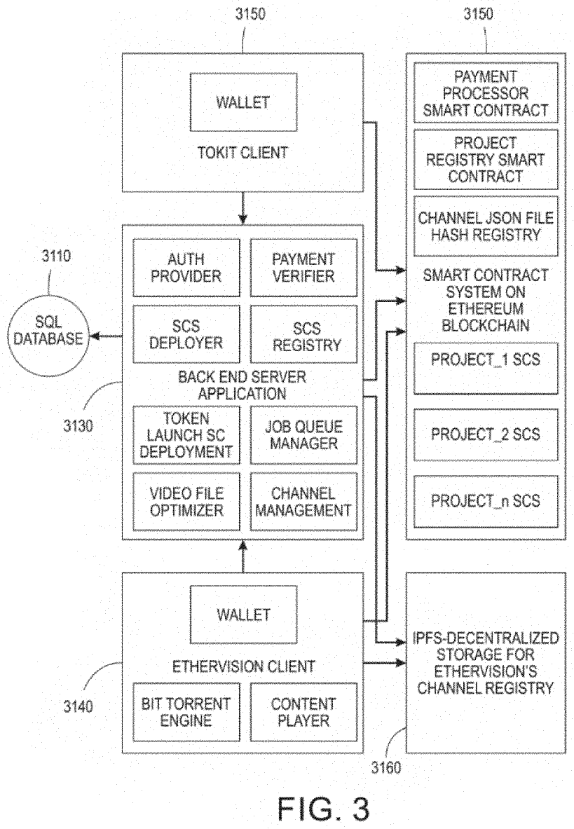

FIG. 3 illustrates an overview of the general architecture of a platform for the decentralized distribution system for digital media of FIG. 2.

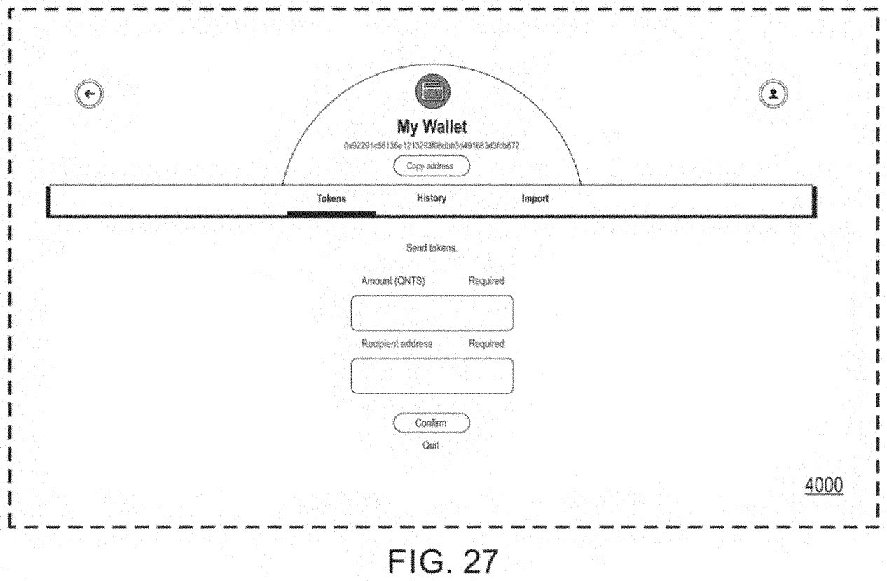

As illustrated in FIG. 3, a client or user, using a front end application (“Tokit Client”) or user interface 3120, as described in more detail below with respect to the description of FIGS. 9-27, can create and manage a project for distribution on the decentralized distribution system.

As noted below, the client or user needs a wallet to utilize the front end application or user interface 3120. The wallet can either be created by the user locally, or if the user already has an appropriate wallet, the wallet can be imported into the front end application or user interface 3120.

The front end application or user interface 3120 interacts with a back end server application 3130 or a back end server 3150.

The back end server application 3130 provides support for authenticating a wallet holder; verifying payment for the project creation services and management thereof; deploying the smart contract system for the project; registering the smart contract system with the decentralized distribution system; management of the job queue with respect to the projects; client channel management; token launch smart contract deployment; and video file optimization. These various functions are described in more detail below.

The back end server application 3130 also communicates with a SQL database 3110 to add an entry corresponding to each project created through the front end application or user interface 3120.

Another front end application (“Ethervision Client”) or user interface 3140 enables a user/client to access and/or consume the content on the decentralized distribution system, wherein consumption may include single use or time-limited viewing of the content, single use or time-limited listening of the content, or purchasing of the content. The front end application or user interface 3140 would include access to the user's/client's wallet, a content player, and a content delivery system utilizing various content sharing communication protocols to share content, data, and/or electronic files over the internet.

One example of a content sharing communication protocol is a communication protocol for peer-to-peer file sharing, which is used to distribute data and/or electronic files over the Internet, such as BitTorrent™. The content sharing communication protocol, as described herein, is not limited to a communication protocol for peer-to-peer file sharing, which is used to distribute data and electronic files over the Internet, but includes any communication protocol for sharing content, data, and/or electronic files over the internet.

The front end application or user interface 3140 communicates with the back end server application 3130 and the back end server 3150 to acquire the necessary information and permission to consume the desired content. The front end application or user interface 3140 utilizes a communication protocol for sharing content, data, and/or electronic files over the internet to acquire the content from an InterPlanetary File System 3160, as described in more detail below. The InterPlanetary File System 3160 decentralized storage of the content for distribution over the decentralized distribution system.

The back end server 3150 provides support for the processing of payments through smart contracts, the registration of projects and the projects' smart contracts; registration of channel JavaScript™ object notation file hash, and the managing of the various projects. The smart contracts are supported on Ethereum block chains.

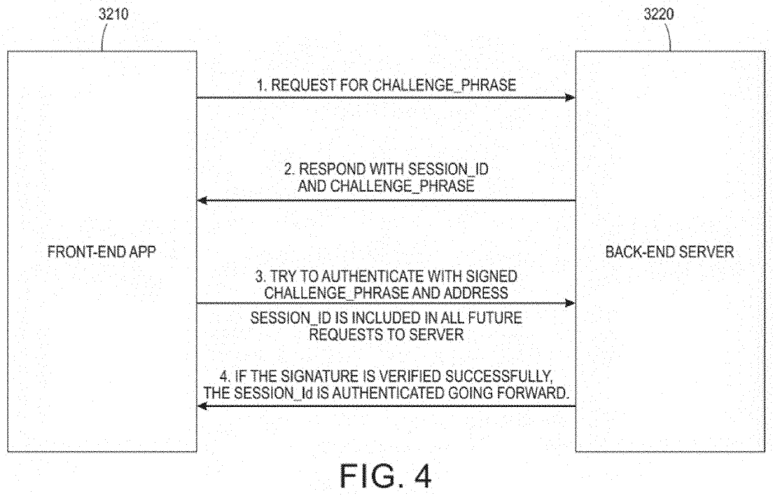

FIG. 4 is a block diagram illustrating a process for authenticating a wallet holder in the decentralized distribution system for digital media.

With respect to FIG. 4, since the decentralized distribution system operates on block chain technology, funds never flow through the servers of the decentralized distribution system. Thus, in order for the user to be able to interact with the block chain based decentralized distribution system; the user needs a private key. The user interface of the decentralized distribution system allows the user to generate one locally, in their browser without interacting with the servers of the decentralized distribution system.

The users encrypt the private key with password and download it in a special file called “wallet.” Recovery mechanisms through a 12 word mnemonic phrase, using BIP32 or BIP39 can be provided. It is noted that the user's public key and address are derived from their private key.

Once the user's wallet is created or imported in the front-end application (user interface) of the decentralized distribution system, the user can interact with the decentralized distribution system's block chain, namely an Ethereum block chain.

In an Ethereum block chain, addresses are one hundred sixty bit values represented in a forty character long hexadecimal format.

It is further noted that some of the functionalities of the decentralized distribution system are centralized (off-chain, with traditional servers and SQL databases), and some on-chain. This bifurcation of functionalities is to ensure a trust-minimized solution, while maintaining performance benefits of a centralized approach.

To authenticate a wallet holder in the decentralized distribution system, the user needs to prove the user has access to the private key of their address. This authenticated process is illustrated in FIG. 4.

As illustrated in FIG. 4, a user, through a front end application or user interface 3210, queries a back end server 3220 for a challenge phrase to sign. The back end server 3220 creates a session and generates a random thirty-six character long string challenge phrase and returns the challenge phrase and session id to the client via the front end application or user interface 3210.

The client signs, through the front end application or user interface 3210, the challenge phrase using an elliptic curve digital signature algorithm. The front end application or user interface 3210 sends the signature, session id, and its address to the back end server 3220 for verification. The back end server 3220 verifies the elliptic curve digital signature algorithm signature against the claimed address, and if correct, the back end server 3220 authenticates the session id.

Upon completion of this back and forth hand shake, the session_id is considered authenticated by the back end server 3220. The client will include the authenticated session_id in the header in all future requests.

With respect to project management, a user can create a project through the user interface of the decentralized distribution system. The project is an entity that has some elements which are off-chain and some which are on-chain.

For example, off-chain elements are name, description, and/or owner (for listing purposes). On-chain elements are a set of smart contracts that are deployed on Ethereum. Entities can interact with these smart contracts either through the user interface of the decentralized distribution system or programmatically directly with the Ethereum block chain. Each deployed smart contract has a unique address on Ethereum and an application binary interface that describes its functions and attributes.

The decentralized distribution system utilizes ERC20 token contracts with extended functionality to enable external third party applications to be built to work with this token contract and enables the token contract to be connected to rights/rewards contract.

This smart contract acts as the token ledger. Internally, the token contract stores the amount of tokens each address holds in an attribute named ‘mapping (address=>uint256) balances’, and through its different functions, tokens can be transferred from one address to another. The token contract has the following functions, as set forth in the pseudocode below:
‘transfer(address_to, uint256_value)’
‘balanceOf(address_owner)’
‘approve(address_spender, uint256_value)’
‘allowance(address_owner, address_spender)’
‘transferFrom(address_from, address_to, uint256_value)’

The decentralized distribution system also utilizes rights/rewards smart contracts. The rights/rewards contract acts like a value bucket. Any entity can add ETH (Ethereum's native token), or other ERC20 tokens to this bucket. Only token holders can withdraw value from this bucket, proportional to the number of tokens they hold. The rights/rewards contract has the following functions, as set forth in the pseudocode below:
‘depositReward( )’
‘withdrawReward( )’
‘softWithdrawRewardFor(address forAddress)’

The function, “softWithdrawRewardFor,” is called by the token contract before any transfer, on both addresses involved. The rights/rewards contract keeps the eligible reward at that moment in an internal attribute named ‘owed’, and during the ‘withdrawReward’ called by those addresses, the rights/rewards contract takes amount ‘owed’ to them into account, and resets it afterwards. This mechanism ensures tokens remain fungible even during a transfer.

The rights/rewards contract mediates rights, revenue, royalty, and reward acquisition and sharing.

The decentralized distribution system also utilizes token launch smart contracts. With the token launch contract, project owners can choose to launch their project tokens to the world. The token launch contract handles the logic necessary for exchanging ETH (native Ethereum token) and project tokens.

At the time of the token launch contract's creation (deployment), the owner allocates a number of tokens to it, and specifies the price in ETH (or a specific ERC20 token) of each token. Any entity (address) that sends funds to the token launch contract will receive project tokens in exchange.

After the launch is successfully over, the token launch contract will send the resulting funds to the beneficiary address (usually the owner, unless otherwise specified during the creation, by the owner). In case the token launch contract fails (minimum threshold set during the creation is not reached), any entity that participated can recover their funds.

The token launch contract has the following functions, as set forth in the pseudocode below:
‘start( )’
‘fund( )’
‘withdrawFunding( )’
‘withdrawForOwner( )’

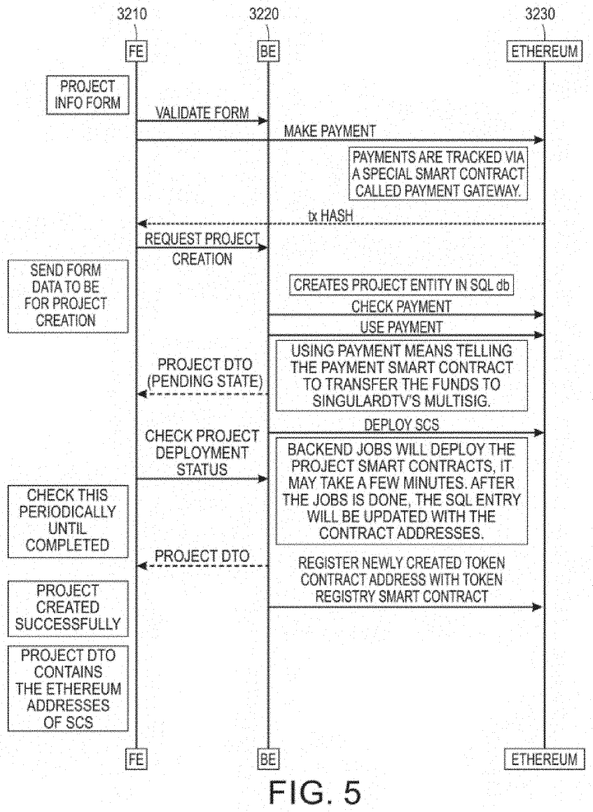

FIG. 5 is a block diagram illustrating a process for creating a project in the decentralized distribution system for digital media. As illustrated in FIG. 5, a user can create a project through the front-end app 3210 or the user interface 3120 of FIG. 3. The user interface 3210 prompts the user for the project name and description and prompts the user for token parameters; i.e., name (e.g. Quantum), abbreviation (aka Token Symbol, e.g. QNTM), and total amount (e.g. 1,000,000). The user chooses a payment method and confirms payment. If the payment is done using US dollars, a payment token (tx hash) is given to the client by a payment gateway (e.g. Stripe).

If the payment is done using ETH, a transaction receipt is returned to the client by a payment smart contract on the Ethereum block chain 3150 of FIG. 3. The user or client send the transaction directly to the payment processor smart contract on the Ethereum block chain 3230 (the Ethereum block chain 3150 of FIG. 3).

The payment receipt (tx hash) is sent to the back end server 3220 alongside with the collected information about the project as part of a project creation request.

The back end server 3220 verifies the payment, and if ok adds the project creation into a job queue and returns a job id to the client.

Upon running the projection creation job, the back end server 3220 adds an entry to a SQL database (SQL database 3110 of FIG. 3) associated with the project and flags the job as pending. The back end server 3220 then deploys two smart contracts (token and rights/rewards), with the appropriate parameters. All the created tokens are allocated to the user (project creator).

When the deployment is done, register the two contracts' addresses are registered in a database, in effect linking the two contracts to the project owner (for listing purposes only).

Also, a transaction is sent to a registry smart contract to register the two newly created smart contracts to user's address. This step ensures an immutable record of every created smart contract system exists on the block chain.

The client can verify the job creation. Once the creation is done, the user can see the newly created project in their user interface's dashboard.

The user can now transfer the newly created tokens to any Ethereum address, using the front end interface 3120 of FIG. 3. Since the tokens are directly linked to a rights/rewards contract, this transfer of tokens represents transfer of rights, effectively turning the front end interface 3120 of FIG. 3 into a rights management gateway.

As described above, the front end interface 3120 of FIG. 3 is a hybrid application, with some functionality performed by a back-end server(s) 3220.

The front end interface 3120 of FIG. 3 uses two global (as opposed to per-project) smart contracts to function properly.

The first global smart contract is a payment processor smart contract which processes payments made in ETH. This smart contract acts as an escrow. The user sends their ETH to the payment processor smart contract, and the payment processor smart contract holds their tokens and registers the payment.

After the back end server completes the project creation job, the payment processor smart contract sends the fund to decentralized distribution system's cold storage and marks user's payment as “used.” This payment mechanism makes everything as asynchronous as possible, and prevents user fund losses in case of browser crashes or any other technical problems on user's end.

The payment processor smart contract has the following function, as represented by pseudocode below:
‘depositPayment( )’ #called by user to make a payment
‘getUserDeposit(address_user) returns int’ #called by our server to check the deposited funds by_user
‘consumeUserDeposit(address_user) onlyServer’ #called after the creation job is done. This may have a modifier that requires a private key to execute it.
‘returnUserDeposit(address_user) onlyServer’ #a user can ask to cancel his deposit and get money back

The second global smart contract is a project registry smart contract. Whenever a new project smart contract system is created, the project smart contract system is registered that into this registry (project registry smart contract). The front-end app gets the list of current user's projects from this registry (project registry smart contract).

This registry (project registry smart contract) is used as opposed to just the SQL database to make the platform is more decentralized, and less prone to censorship.

The project registry smart contract has the following function, as represented by pseudocode below:
‘set(address_user, address_token, address_fund)’ #Internally registers these values in a map with the key being the user address, _fund is the rights/rewards contract
‘get(address_user)’ #queries the registry about user smart contract system addresses, can return multiple pairs of (token, fund)

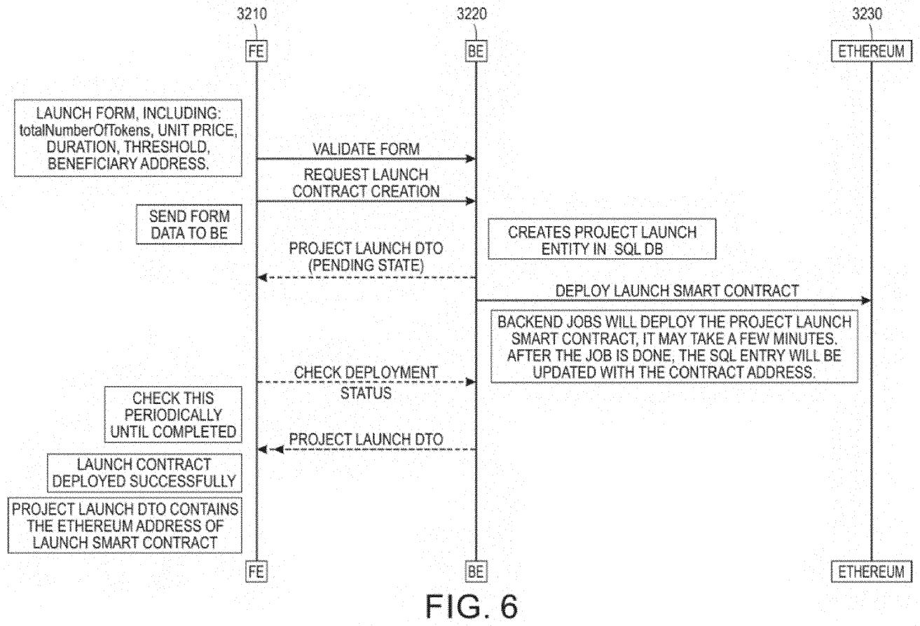

FIG. 6 is a block diagram illustrating a process for launching a created token on the decentralized distribution system for digital media. As illustrated in FIG. 6, after the project has been created, a user can launch their tokens to the world. If the user chooses to do that, the user is prompted, by the front end 3210, for total number of tokens the user wants to sell and the price of each token denominated in ETH. The user sets the duration of the launch and the user can set a minimum threshold and an external address to which the funds go.

After these values are collected, a request is sent from the front end 3210 to the back end server 3220 with the collected parameters. The back end server 3220 adds a job for the token launch contract deployment. The token launch contract deployment is sent to the Ethereum block chain 3230.

After the deployment of the token launch contract, the project will have three smart contracts.

The token launch smart contract has a public method named ‘fund( )’ which accepts ETH (ethereum native token). This method calculates the corresponding tokens and sends them to the address of the entity calling it.

An example of pseudocode of a launch contract is as follows:

The Token Launch contract has a state machine, with the following possible stages represented by the pseudocode below:

Stages {
Deployed,
GoingAndGoalNotReached,
EndedAndGoalNotReached,
GoingAndGoalReached,
EndedAndGoalReached
}

The default stage is ‘Deployed’. In order for fundraising campaign to start (change to ‘GoingAndGoalNotReached’), a transaction is sent by the owner, calling the ‘start( )’ method. The ‘startTime’ is set in the ‘start( )’ method. After that, everything is automated and the owner cannot change the behaviors. Any Ethereum entity can participate in the token launch. The user interface allows anyone to create a wallet and participate. This can be realized by a dedicated page for each project token launch.

The project owner can customize the dedicated token launch page with a WYSIWYG editor, allowing the owner to upload images, embed videos, and add content to promote the project.

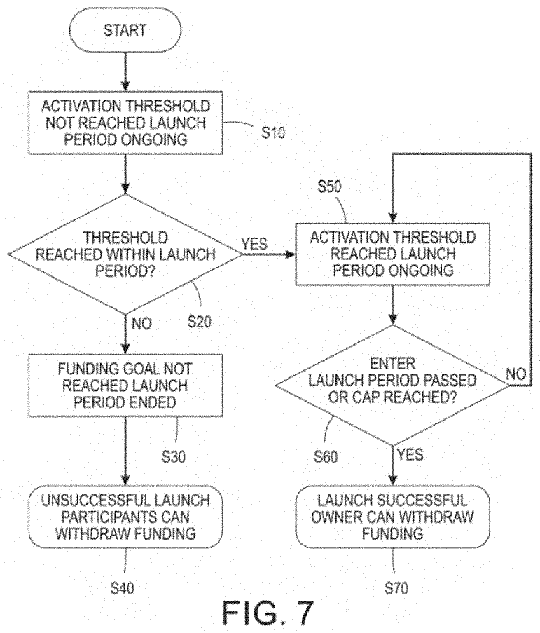

The state, as illustrated in FIG. 7, can be changed if there is a minimum threshold set by the owner during the creation (step S10), and that threshold is not reached at the end of “launch duration” (step S20). In this situation, the state will change to ‘EndedAndGoalNotReached’ (step S30) and all entities that participated in the token launch, will be able to get their ETH back through ‘withdrawFunding( )’ method (step S40).

If the maximum duration has not been reached (step S60), and minimum threshold is reached (Step S50), the state will change to ‘GoingAndGoalReached’.

After the duration of the launch has been reached, if the minimum threshold has been reached, the state changes to ‘EndedAndGoalReached’ (step S70).

It is noted that the user interface interacts with the launch smart contract directly, and not through the back end server.

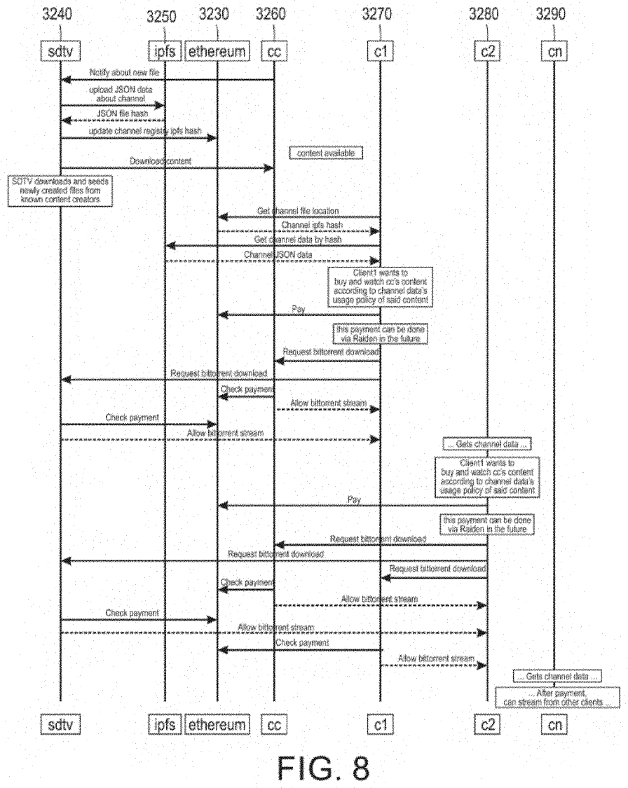

FIG. 8 is a block diagram illustrating a process for content distribution on the decentralized distribution system for digital media.

As illustrated in FIG. 8, a client channel 3260 notifies the decentralized distribution system 3240 that a new file (content) should be added to a channel. The decentralized distribution system 3240 uploads, to the InterPlanetary File System 3250, JavaScript™ object notation data about the channel and new filed associated therewith.

The InterPlanetary File System 3250 creates a hash corresponding to JavaScript™ object notation data and communicates the hash to the decentralized distribution system 3240. The decentralized distribution system 3240 registers the channel InterPlanetary File System hash in the appropriate registry smart contract.

Optionally, the decentralized distribution system 3240 may download the content to the channel, thereby seeding the newly created content (files) from the content creators.

An Ethervision client (c1) 3270, in searching for content, requests the channel file location from the associated registry smart contract. The Ethereum block chain 3230 provides the Ethervision client (c1) 3270 with the channel InterPlanetary File System hash. The Ethervision client (c1) 3270 uses the channel InterPlanetary File System hash to request the channel data from the InterPlanetary File System 3250. The InterPlanetary File System 3250 provides the Ethervision client (c1) 3270 with the channel JavaScript™ object notation data.

Upon reviewing the channel JavaScript™ object notation data, the Ethervision client (c1) 3270 decides to purchase or consume the content of the channel according to the usage policy of the content. To purchase or consume the content of the channel according to the usage policy of the content, the Ethervision client (c1) 3270 provides a payment to the Ethereum block chain 3230.

The Ethervision client (c1) 3270 may provide a request to the client channel 3260 for a communication protocol for sharing content, data, and/or electronic files over the internet download or may provide a request to the decentralized distribution system 3240 for a communication protocol for sharing content, data, and/or electronic files over the internet download.

In addition, the Ethervision client (c1) 3270, optionally, may provide a request to other peers, such as other Ethervision clients, for a communication protocol for sharing content, data, and/or electronic files over the internet download or, optionally, may provide a request to a data distribution service server for a communication protocol for sharing content, data, and/or electronic files over the internet download.

The client channel 3260 and/or the decentralized distribution system 3240, in response to a communication protocol for sharing content, data, and/or electronic files over the internet download request, communicate with the Ethereum block chain 3230 to determine if proper payment has been received.

If the proper payment has been received, the client channel 3260 and/or the decentralized distribution system 3240 allow a communication protocol for sharing content, data, and/or electronic files over the internet stream to the Ethervision client (c1) 3270.

An Ethervision client (c2) 3280, in searching for content, requests the channel file location from the associated registry smart contract. The Ethereum block chain 3230 provides the Ethervision client (c2) 3280 with the channel InterPlanetary File System hash. The Ethervision client (c2) 3280 uses the channel InterPlanetary File System hash to request the channel data from the InterPlanetary File System 3250. The InterPlanetary File System 3250 provides the Ethervision client (c2) 3280 with the channel JavaScript™ object notation data.

Upon reviewing the channel JavaScript™ object notation data, the Ethervision client (c2) 3280 decides to purchase or consume the content of the channel according to the usage policy of the content.

To purchase or consume the content of the channel according to the usage policy of the content, the Ethervision client (c2) 3280 provides a payment to the Ethereum block chain 3230.

The Ethervision client (c2) 3280 may provide a request to the client channel 3260 for a communication protocol for sharing content, data, and/or electronic files over the internet download or may provide a request to the decentralized distribution system 3240 for a communication protocol for sharing content, data, and/or electronic files over the internet download. In addition, the Ethervision client (c2) 3280, optionally, may provide a request to other peers, such as other Ethervision clients, for a communication protocol for sharing content, data, and/or electronic files over the internet download or, optionally, may provide a request to a data distribution service server for a communication protocol for sharing content, data, and/or electronic files over the internet download.

The client channel 3260 and/or the decentralized distribution system 3240, in response to a communication protocol for sharing content, data, and/or electronic files over the internet download request, communicate with the Ethereum block chain 3230 to determine if proper payment has been received.

If the proper payment has been received, the client channel 3260 and/or the decentralized distribution system 3240 allow a communication protocol for sharing content, data, and/or electronic files over the internet stream to the Ethervision client (c2) 3280.

An Ethervision client (c3) 3290, in searching for content, requests the channel file location from the associated registry smart contract. The Ethereum block chain 3230 provides the Ethervision client (c3) 3290 with the channel InterPlanetary File System hash. The Ethervision client (c3) 3290 uses the channel InterPlanetary File System hash to request the channel data from the InterPlanetary File System 3250. The InterPlanetary File System 3250 provides the Ethervision client (c3) 3290 with the channel JavaScript™ object notation data.

Upon reviewing the channel JavaScript™ object notation data, the Ethervision client (c3) 3290 decides to purchase or consume the content of the channel according to the usage policy of the content. To purchase or consume the content of the channel according to the usage policy of the content, the Ethervision client (c3) 3290 provides a payment to the Ethereum block chain 3230.

The Ethervision client (c3) 3290 may provide a request to the client channel 3260 for a communication protocol for sharing content, data, and/or electronic files over the internet download or may provide a request to the decentralized distribution system 3240 for a communication protocol for sharing content, data, and/or electronic files over the internet download. In addition, the Ethervision client (c3) 3290, optionally, may provide a request to other peers, such as other Ethervision clients, for a communication protocol for sharing content, data, and/or electronic files over the internet download or, optionally, may provide a request to a data distribution service server for a communication protocol for sharing content, data, and/or electronic files over the internet download.

The client channel 3260 and/or the decentralized distribution system 3240, in response to a communication protocol for sharing content, data, and/or electronic files over the internet download request, communicate with the Ethereum block chain 3230 to determine if proper payment has been received.

If the proper payment has been received, the client channel 3260 and/or the decentralized distribution system 3240 allow a communication protocol for sharing content, data, and/or electronic files over the internet stream to the Ethervision client (c3) 3290.

The content distribution module 3140 of FIG. 3 may a standalone desktop or mobile app that allows a user to play video and audio content provided by the content providers of the decentralized distribution system.

The content provider, a project creator using the front end 3120 of FIG. 3, uploads the video or audio onto the decentralized distribution system. Since the distribution is done peer-to-peer, using, for example, communication protocol for sharing content, data, and/or electronic files over the internet technology, content creators are responsible for “seeding” their files, so others peers can download the files from the decentralized distribution system.

Each entity may have a channel on the decentralized distribution system, and each channel can have any number of video or audio content. The decentralized distribution system may have an official, curated channel. Adding content to a channel can be done by the owner of the channel or someone who has been given access by the owner.

Adding a video or audio file to the decentralized distribution system is done by going through a step-by-step wizard provided by the decentralized distribution system's user interface. Initially, a user is prompted for the name, description, category, and tags of the content. The user is then prompted for the address of the project token.

A user is queried to set usage policy for the content. An example would be cost for adding it to library, or cost per view. The content file can be selected (or dragged into the app or user interface). If the file format is not optimal, the file can be sent to the back end server to be converted to an optimized format using an appropriate codec (h264) and sent back to the client.

The file is added to client's communication protocol for sharing content, data, and/or electronic files over the internet library, and a magnet link is generated for the file. Magnet links are links with no files associated with them, just data. The links are an URI standard developed primarily to be used by p2p networks.

Magnet links differ from URLs, for example, in that magnet links do not hold information on the location of a resource but rather on the content of the file or files to which the magnet links link.

Magnet links are made up of a series of parameters containing various data in no particular order. In the case of communication protocol for sharing content, data, and/or electronic files over the internet, the magnet link holds the hash value of the torrent which is then used to locate copies of the files among the peers. The magnet links may also hold filename data or links to trackers used by the torrent.

With magnet links, communication protocol for sharing content, data, and/or electronic files over the internet indexers do not have to store any files, just a few snippets of data. Magnet links can be copy-pasted as plain text by users and shared via email, instant messages, or any other medium.

The magnet link, together with all the information gathered during the content upload is sent to the back end server for registering the newly added content.

The registration is done by adding the newly created item to the SQL database. A complete list of every channel in the database and all their videos is generated in JavaScript™ object notation format. The resulting JavaScript™ object notation file is uploaded to an InterPlanetary File System. The resulting InterPlanetary File System hash is sent to a registry smart contract. This results in a completely decentralized distribution system.

When a user wants to update its channel and content list, the user queries the registry smart contract about the list hash. The decentralized distribution system fetches the list from InterPlanetary File System by hash and updates its internal channel list using the JavaScript™ object notation file.

Using the magnet links of the content files, the user, by connecting to each other, can fetch bits and pieces of each file. The more popular a file, the more people seeding it, and a smoother playing experience.

For less popular files, content providers can add more dedicated peers to host their files.

The user interface of the decentralized distribution system will have the wallet management module integrated into it so that viewers can browse either from the curated official channel or from unofficial channels.

When the user wants to “play” a video or audio content, the user interface of the decentralized distribution system checks the monetization policy of the content provider, and initiates a transaction, sending value tokens to the content's rights/rewards smart contract (inferred from the content's token contract).

The payment is registered in the project's rights/rewards smart contract, and other users can check and see if someone trying to download a file from them has really paid for that content or not. If not, they can refuse to accept that client as a downloader.

FIG. 9 through FIG. 27 illustrate interfaces for the decentralized distribution system for digital media.

The user interface for the decentralized distribution system is a prototype for rights management gateway, aka “Tokit,” and its wallet.

It is noted, as illustrated in FIG. 9, that the “Tokit” interface is built using “cards.” This modular approach allows for other cards to easily and efficiently be slipped into the interface to alter, change, or customize the user experience.

Two icons, as illustrated in FIG. 9, on the top left and right of the display screen 4000 allow for various information and access to functions. Your “Wallet” card and “Create Project” card are the first two cards. Once a user has created “Projects,” the projects reside below the “My Projects” card.

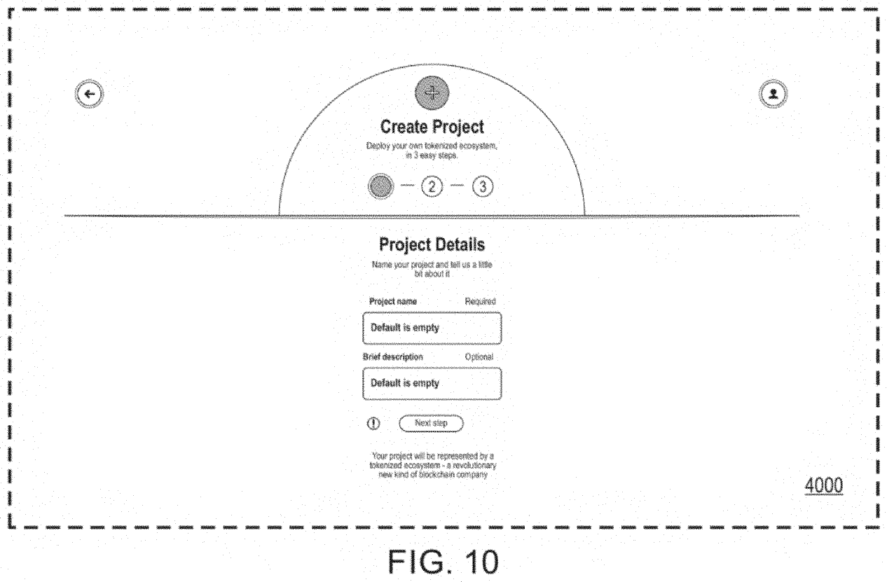

FIG. 10 illustrates the display screen 4000 for creating a project. As illustrated, a user can create a project by entering details about the project in the various provided fields. When the details are properly entered, the user can activate the next step button to move to the next screen. At this screen, a user (artist/creator) creates, as discussed with respect to FIG. 2, through the user interface, a project; names the project; and may provide a description thereof and/or a logo (image). This information is stored or defined in a metadata file.

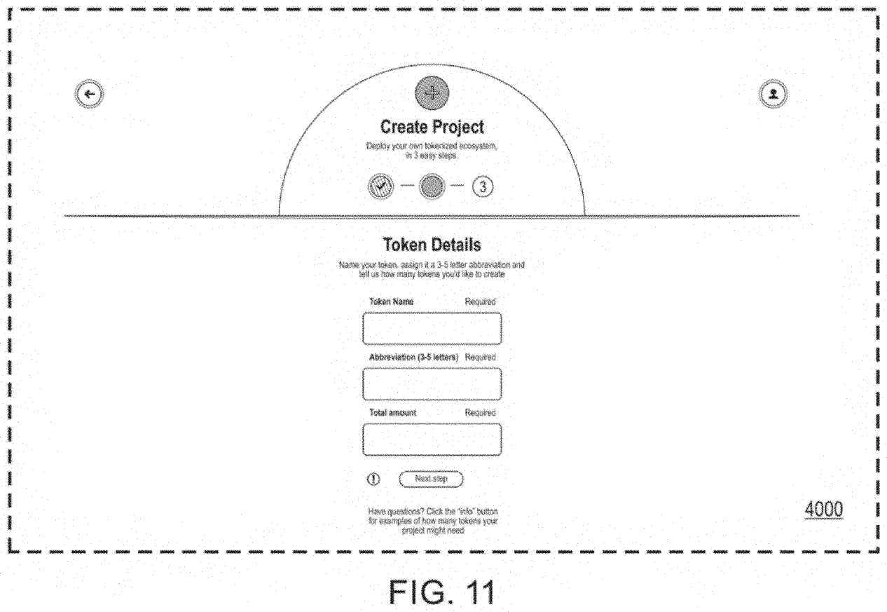

FIG. 11 illustrates the display screen 4000 for entering token details. As illustrated, a user can enter details about the token(s) in the various provided fields. When the details are properly entered, the user can activate the next step button to move to the next screen.

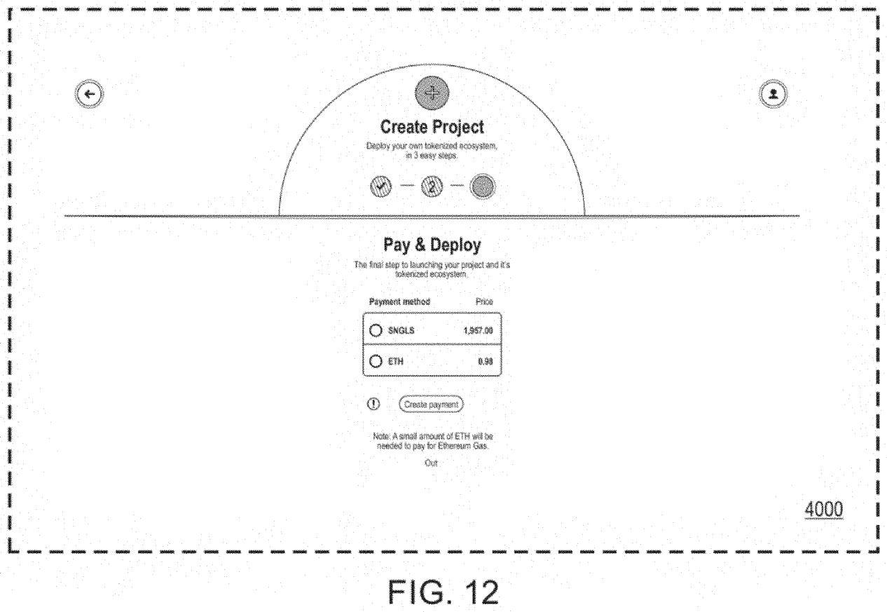

FIG. 12 illustrates the display screen 4000 for paying and deploying the token contract. As illustrated, a user is provided the proper amount for payment and how the user wants to pay for the project's registration. When the completed, the user can activate pay button to move to the next screen.

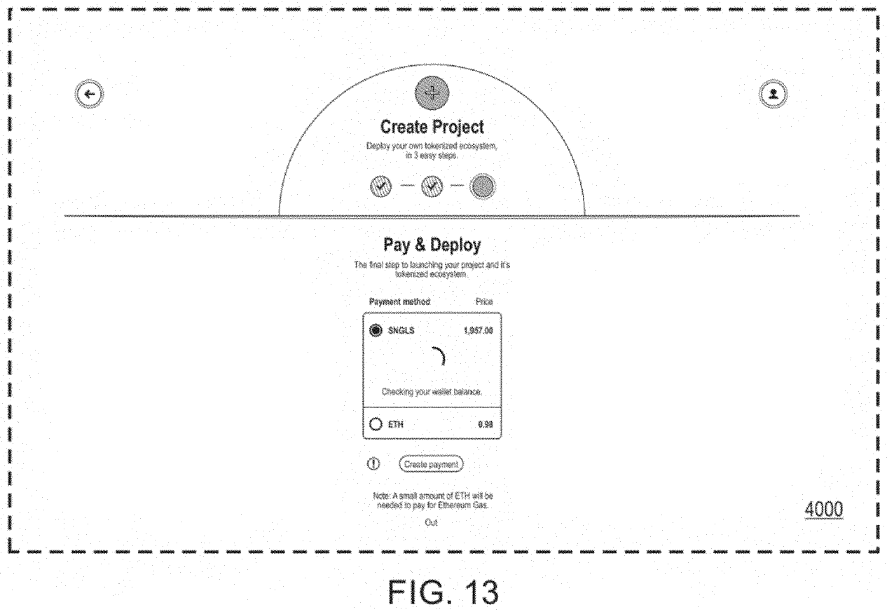

FIG. 13 illustrates the display screen 4000 for allowing the user to select the form of payment.

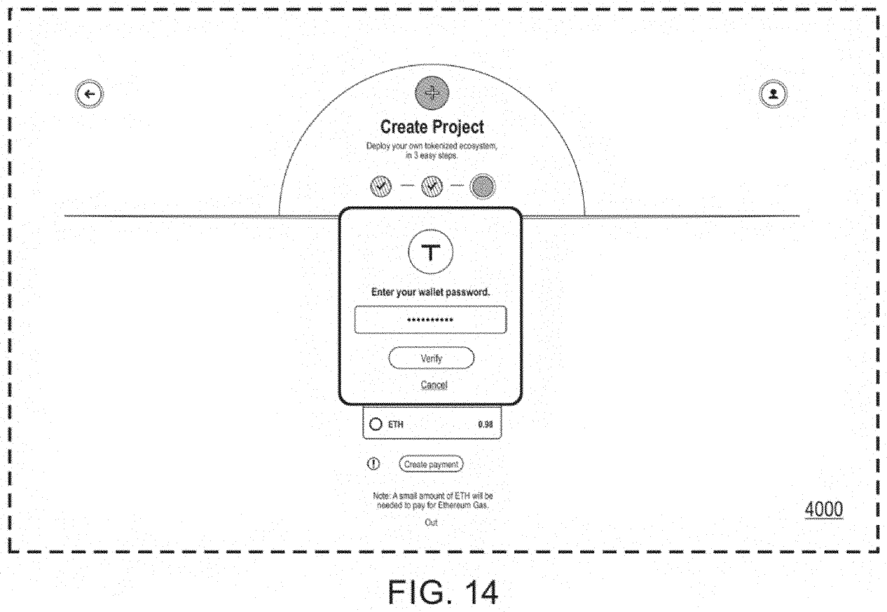

FIG. 14 illustrates the display screen 4000 for providing a window for the user to enter the appropriate password for the user's wallet.

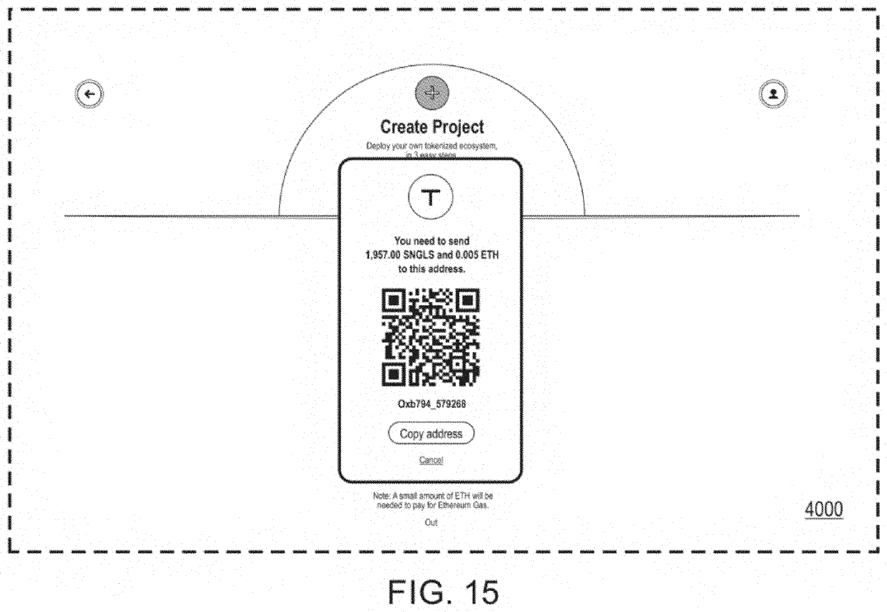

FIG. 15 illustrates the display screen 4000 for providing the address for the payment.

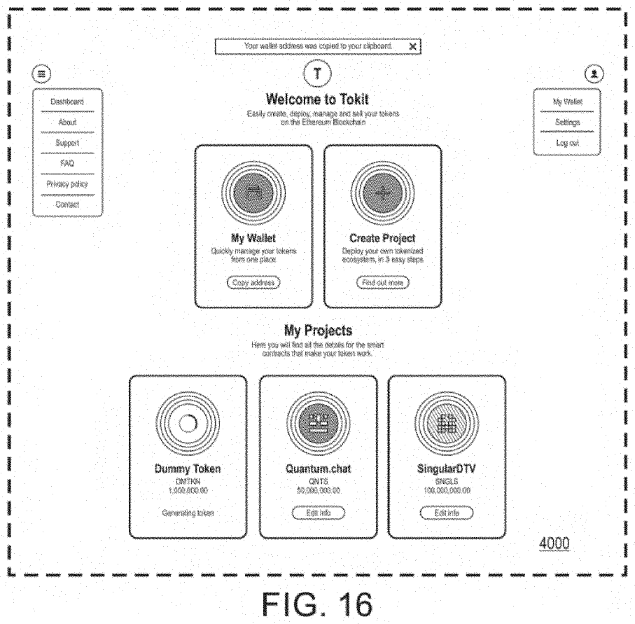

FIG. 16 illustrates the display screen 4000 for informing the user that the project is being created. The display screen 4000 can show the progression of the token (see Dummy Token card). Once the token is generated, the user will have access to the token by activating the associated token card.

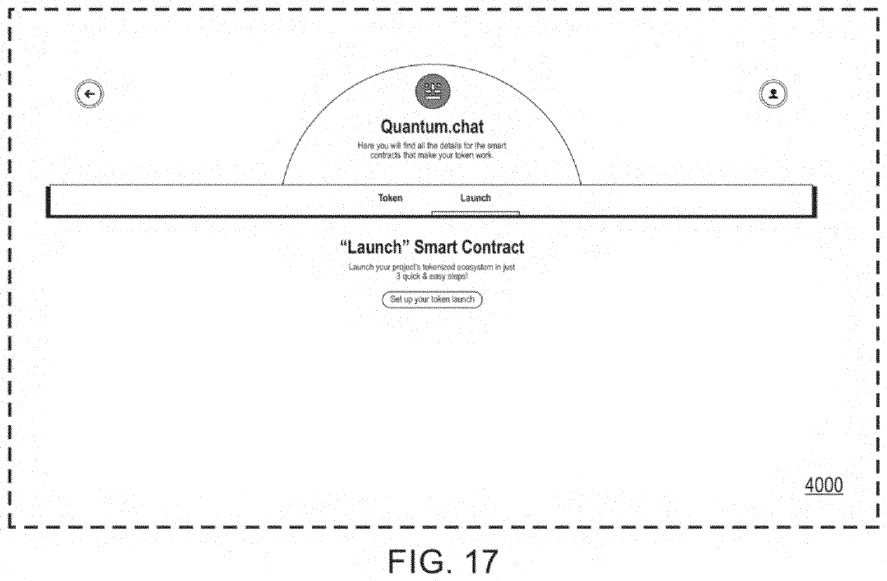

FIG. 17 illustrates the display screen 4000 for providing the entry point for setting up a token launch for project funding.

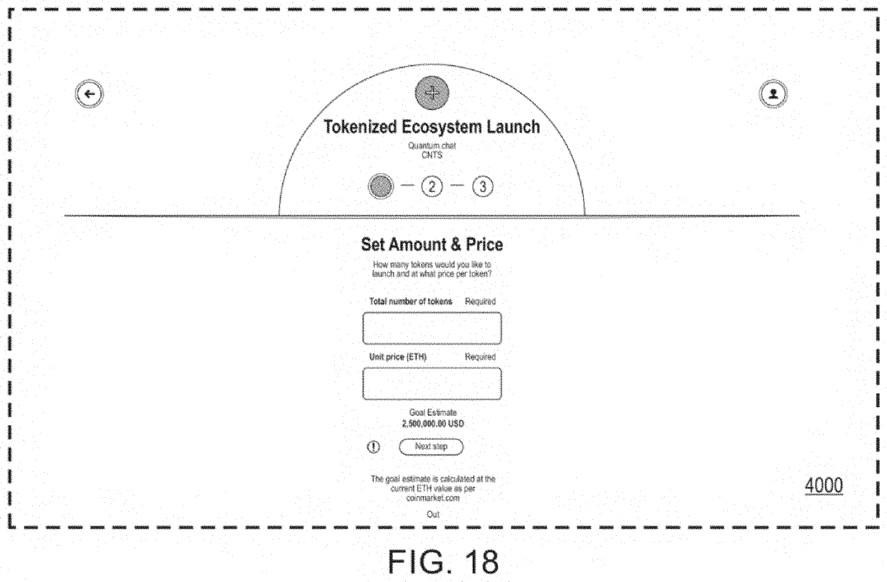

FIG. 18 illustrates the display screen 4000 for providing a window for the user to enter the details about the launch, such as the number of token to be offered and the price thereof.

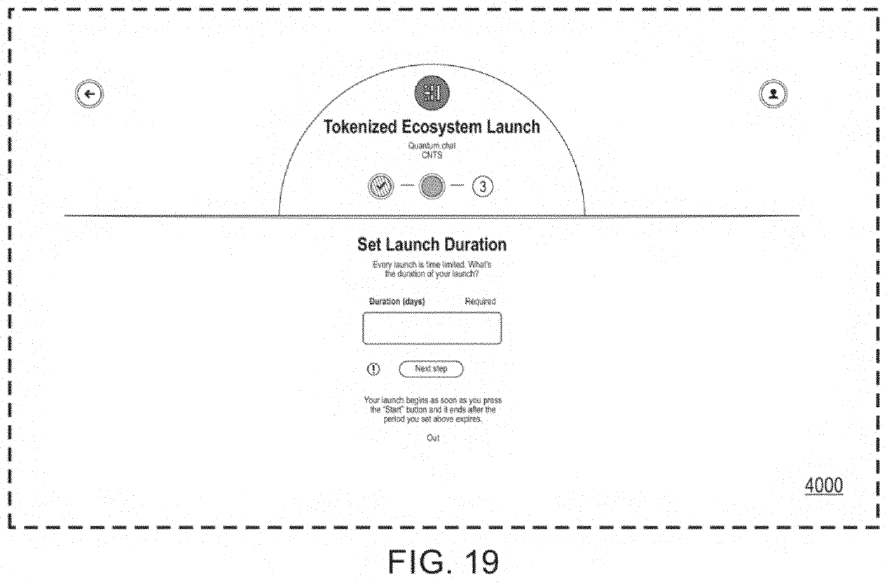

FIG. 19 illustrates the display screen 4000 for providing a window for the user to set the launch duration.

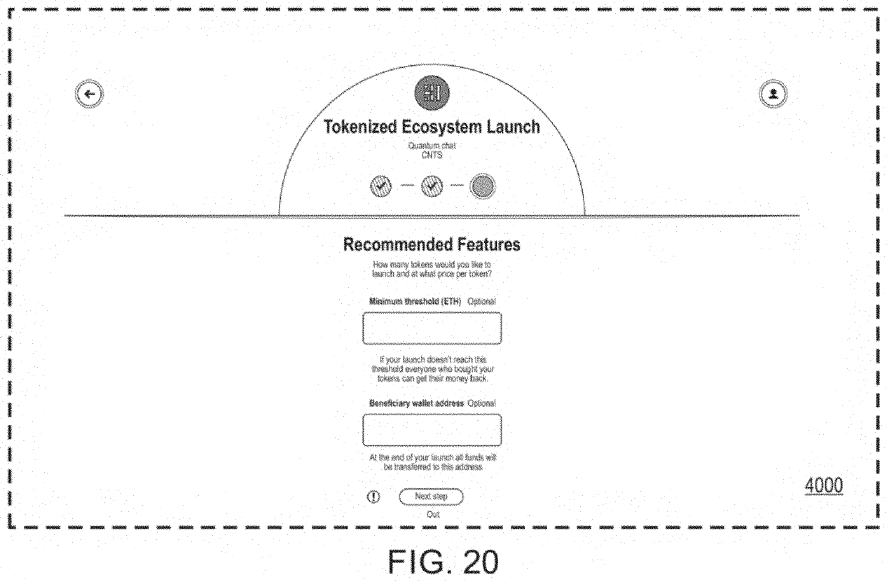

FIG. 20 illustrates the display screen 4000 for providing a window for the user to set the launch's threshold and beneficiary wallet address.

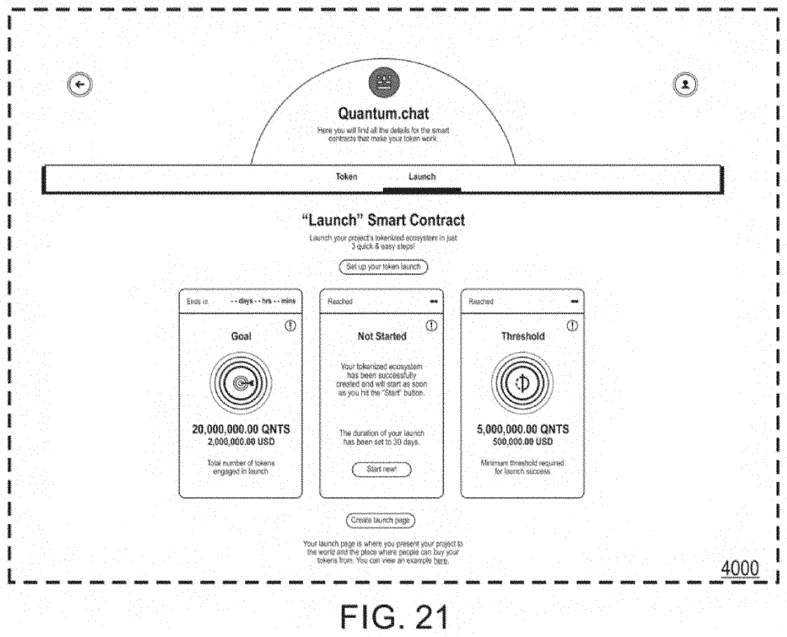

FIG. 21 illustrates the display screen 4000 for providing a window for the user to start the launch. The display screen 4000 can also provide a button to enable the user to create a launch page that may provide information to the public about the project being funded.

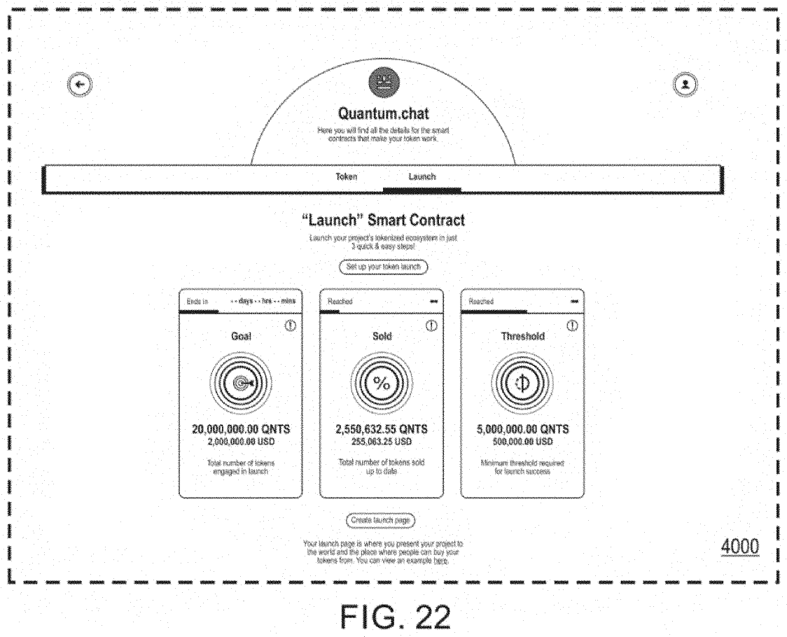

FIG. 22 illustrates the display screen 4000 for informing the user of the progression of the launch.

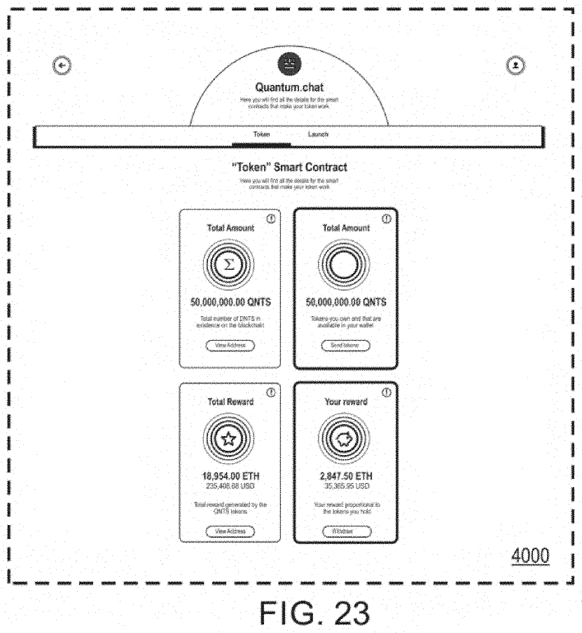

FIG. 23 illustrates the display screen 4000 for allowing the user to perform various administrative functions relating to the user's projects.

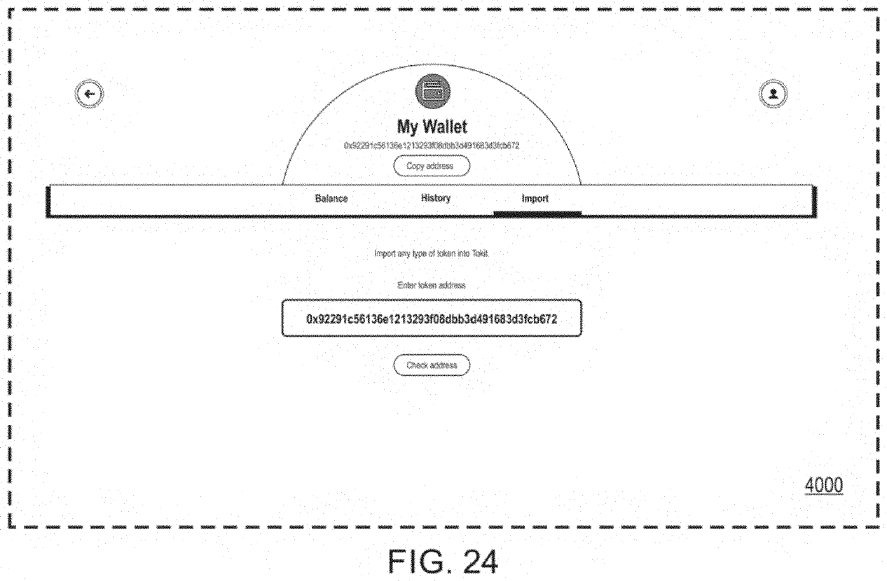

FIG. 24 illustrates the display screen 4000 for allowing the user to add token to the user's wallet.

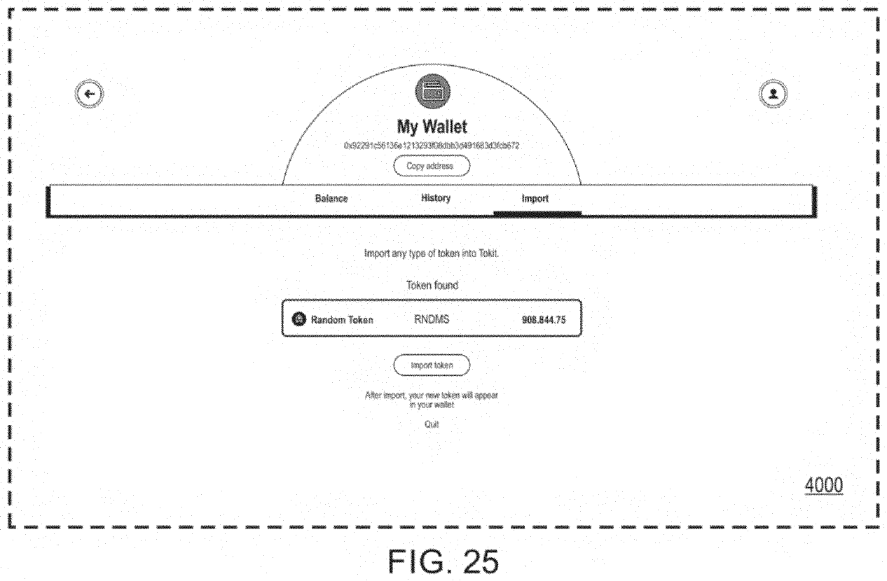

FIG. 25 illustrates the display screen 4000 for informs the user of the addition of the token to the user's wallet.

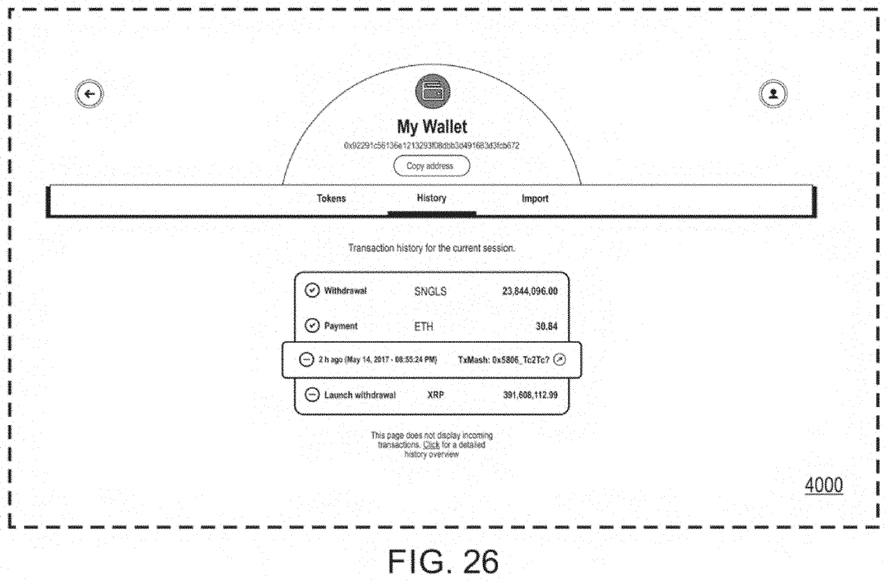

FIG. 26 illustrates the display screen 4000 for the main interface for the user's wallet.

The decentralized distribution system, described above, allows uses and rights to be managed in more complex ways than would be possible with a cryptocurrency which do not support smart contracts. Rights are not merely registered to a block chain address but are programmed to respond to conditions.

With a smart contract system and the associated cryptotoken ecosystem, it is possible, for example, to set up terms where purchasing the right to stream two movies automatically gives the customer tokens (in this context, reward points) toward purchase of a book. The data and logic allowing this is all stored within the smart contracts involved, with the underlying block chain acting merely as a log.

An example of how decentralized distribution system may be used, consider the case of three film-school students, Alice, Bob, and Eve who have agreed to make a short film together. They determine that they need $20,000 to achieve their goal, but they only have $10,000. Alice puts in $4,000, Bob puts in $4,000, and Eve puts in $2,000. This is only half of what they budgeted for their short film project so they come to the decentralized distribution system and set up a project.

They name the project “Short Film Project” and give it a short description. Alice takes the lead as the producer and custodian of the money. She creates a token called SHRTFLM, issuing 20,000 tokens at $1 of value per token. Of those, 4,000 are reserved to Alice, 4,000 are reserved for Bob, and 2,000 tokens for Eve. The tokens represent the dollar value they contributed to their film.

As the money manager for the project, Alice takes possession of the SHRTFLM tokens and sends the correct amounts to Bob and Eve as well as assigns the 10,000 unallocated tokens to the Launch Contract. Sending the tokens where they need to go could be automated but giving Alice maximum control to adjust amounts as needed in the early stages is an important measure for building confidence in a process that may be unfamiliar to all involved.

The other 10,000 tokens are used in a funding campaign. Their goal is to raise the other $10,000 that they need to make their short film. Anyone with an Internet connection and browser can go to the decentralized distribution system site and trade Ether for SHRTFLM tokens in a dollar for dollar swap. That is, if Ether is selling at the time for $50 each, then one Ether acquires fifty SHRTFLM tokens. A launch contract is created when the project is created and then deployed to manage this fund raising effort.

When they reach their goal, the campaign contract automatically sends $10,000 worth of Ether to Alice's address so she can withdraw it and use the proceeds to make the short film. It is low budget by studio standards but quite well financed for a student project.

Rather than release their masterpiece to theaters or a digital platform like Netflix™, the three partners upload the finished product to the decentralized distribution system, in order to use its capabilities to make the movie available for streaming viewers. They require that people who wish to see the movie to purchase a predetermined amount of Ether (paid into the rights/rewards Contract), which will give them twenty-four hours to view the movie as many times as they like.

The price is low by theater standards, where distributors and staff must be paid out of ticket sales. The price is also too low for it to be economical to take credit cards. A cryptocurrency-based system removes these obstacles.

Payments for viewing the movie go directly to the rights/rewards smart contract which automatically calculates what portion of the proceeds any given entity (as determined by its address) is entitled to withdraw.

Since the contract code is registered on the block chain and immutable, there is no possibility for creative accounting techniques to alter anyone's payout.

The rights/rewards smart contract executes against the known funds and everyone is able to withdraw exactly the correct proportion.

As utilized above, the block chain technology utilizes a distributed database that includes and maintains an ever growing list of data records. Being distributed, block chain technology improves data recording technology by making data recording effectively tamper and revision proof. For example, utilizing block chain technology as described above, public ledgers of transactions for cryptocurrencies, such as bitcoin, name-coin, and so on are made effectively tamper and revision proof.

In other words, conventional technologies required data (transaction) recording to be done on a private platform to effectively prevent undesired tampering or revisions of the data, whereas utilizing the block chain technology as described above, data (transaction) recording can be effectively moved off a private platform to a public platform, thereby allowing data transparency while effectively preventing undesired tampering or revisions of the recorded data.

Moreover, block chain technology, as described above, enables decentralized digital currencies, because bitcoin transactions are verified by network nodes (e.g., addresses), and recorded in the public, distributed ledgers.

Furthermore, block chain technology, as described above, with the use of a peer-to-peer network and a distributed timestamping server, block chain technology manages autonomously such that a block chain is a distributed ledger that can record transactions efficiently and in a verifiable and permanent way. The ledger can also be programmed to trigger transactions automatically.

Moreover, in the various embodiments described above, unlike conventional platforms, where format and delivery limitations require the various content verticals (Film, TV, Books, Music, etc.) to be siloed into different sections of the user interface, the above-described transactional platform allows for the mixing of content verticals in the same user experience, whereby related titles in various content verticals can be displayed in the same search and can be bundled together into cohesive channels.

In addition, the various embodiments described above, block chain technology is utilized to reduce the gap time from the point of sale to the disbursement of revenues due to the nature of decentralized ledger technology, allowing revenue to be accounted for quickly and immutably, thereby effectively eliminating the need for paper statements and seasonal audits.

The above described utilization of the block chain technology and decentralized distributive system provides multi-layer content security, which provides stronger anti-piracy and content security measures than conventional industry standard protocols.

Furthermore, the above described utilization of the block chain technology and decentralized distributive system enables transparency of transactions, due to logging on a public block chain, to provide more insight into the data around content ownership.

Also, the above described utilization of the block chain technology and decentralized distributive system provides streamlined digital rights management though peer-to-peer content distribution and delivery, thereby removing intermediary bodies from the process of digital rights management and removing points of obfuscation from the process.

The above described utilization of the block chain technology and decentralized distributive system provides an intellectual property rights owner the ability to license content directly to the end user, streamlining the process and providing the intellectual property rights owner with more data surrounding content usage than provided by conventional systems.

The above described utilization of the block chain technology and decentralized distributive system also allows global access to content for the end user within the same software application, thereby avoiding the need to launch applications in each territory and struggle with regional challenges. The above described utilization of the block chain technology and decentralized distributive system provides the ability to avoid censorship, with a base layer of content deliverable accessible to all, regardless of regional censors and restrictions.

In summary, a method or system for registering digital content with a decentralized distribution system having a front end computing system, the front end computing system including a front end processor, a display, a user interface, and front end memory, the decentralized distribution system having a back end computing system communicatively connected to the front end computing system, the back end computing system including a back end processor and back end memory: communicates, in response to a user's interactions with the user interface of the front end computing system, digital content related information to the back end computing system, the digital content related information corresponding to the user's interactions with the user interface of the front end computing system; registers, with the back end computing system, digital content based upon the received digital content related information; and creates electronic tokens related to the registered digital content, using the back end computing system, in response to information communicated to the back end computing system, the communicated information corresponding to the user's interactions with the user interface of the front end computing system.

The creation of the electronic tokens related to the registered digital content may include assigning ownership to the created electronic tokens.

A method or system for distributing digital content over a decentralized distribution system having a front end computing system, the front end computing system including a front end processor, a display, a user interface, and front end memory, the decentralized distribution system having a back end computing system communicatively connected to the front end computing system, the back end computing system including a back end processor and back end memory: notifies, in response to a user's interactions with the user interface of the front end computing system, the back end computing system that new digital content should be added to a channel of the decentralized distribution system; uploads, using the back end computing system, to a file system, object notation data about the channel and the digital content associated therewith; registers, using the back end computing system, a file system hash associated with the channel in a registry smart contract; searches, in response to a user's interactions with the user interface of the front end computing system, for digital content; requests, in response to a user's interactions with the user interface of the front end computing system, channel file location from associated registry smart contract; provides, from the associated registry smart contract, the file system hash associated with the channel to the front end computing system; requests, in response to a user's interactions with the user interface of the front end computing system, channel data from the file system; provides, from the file system, the object notation data about the channel; and downloads the digital content from the decentralized distribution system based upon the received object notation data about the channel.

The file system may be an InterPlanetary File System.

The object notation data may be JavaScript Object Notation data.

An authentication method or system for a block chain based decentralized distribution system having a front end computing system, the front end computing system including a front end processor, a display, a user interface, and front end memory, the decentralized distribution system having a back end computing system communicatively connected to the front end computing system, the back end computing system including a back end processor and back end memory: electronically creates, using the user interface of the front end computing system, an encrypted electronic private key corresponding to the block chain based decentralized distribution system; electronically creates an electronic public key and an electronic block chain address from the created encrypted electronic private key; electronically sends, from the back end computing system to the front end computing system, a session ID and a randomly generated challenge phrase; electronically signs, through the user interface of the front end application, the randomly generated challenge phrase using an elliptic curve digital signature; electronically sends, to the back end computing system, the elliptic curve digitally created signature, session ID, and the electronic block chain address created from the encrypted electronic private key; and electronically authenticates the session ID when the elliptic curve digitally created signature corresponds to the electronic block chain address created from the encrypted electronic private key.

A method or system for enabling a user to securely create a project with digital rights for a block chain based decentralized distribution system having a front end computing system, the front end computing system including a front end processor, a display, a user interface, and front end memory, the decentralized distribution system having a back end computing system communicatively connected to the front end computing system, the back end computing system including a back end processor and back end memory: electronically creates, using the user interface of the front end computing system, a project by assigning values to token parameters; electronically chooses, using the user interface of the front end computing system, a method of payment; electronically sends, to the front end computing system, a tx hash if the chosen payment method is fiat currency; electronically sends, to the front end computing system, a transaction receipt if the chosen payment method is digital currency; electronically sends, to the back end computing system, the tx hash or the transaction receipt with the values assigned to the token parameters of the created project; electronically adds the created project into a job queue and returning a job id to the front end computing system when the back end computing system verifies payment via the received tx hash or the received transaction receipt; electronically creates and deploys, at the back end computing system, a token smart contract and a rights/reward smart contract, the token smart contract having an address and the rights/reward smart contract having an address; electronically registers, at the back end computing system, the address of the token smart contract and the address of the rights/reward smart contract; and electronically registers, at the back end computing system, a transaction in a registry smart contract to register the token smart contract and the rights/reward smart contract to an address of the user, thereby creating an immutable record of the existence of the created token smart contract and the created rights/reward smart contract on a block chain.

A method or system for enabling a user to securely launch a created token on a block chain based decentralized distribution system having a front end computing system, the front end computing system including a front end processor, a display, a user interface, and front end memory, the decentralized distribution system having a back end computing system communicatively connected to the front end computing system, the back end computing system including a back end processor and back end memory: electronically chooses, using the user interface of the front end computing system, a number of token to be made available and assigning parameters for the number of tokens; electronically sends, to the back end computing system, the number of token to be made available and the assigned parameters for the number of tokens; electronically creates, at the back end computing system, a token launch contract; and electronically registers the token launch contract on a block chain.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

What is claimed is:

1. An authentication method for a block chain based decentralized distribution system having a front end computing system, the front end computing system including a front end processor, a display, a user interface, and front end memory, the decentralized distribution system having a back end computing system communicatively connected to the front end computing system, the back end computing system including a back end processor and back end memory, comprising:
(a) electronically creating, using the user interface of the front end computing system, an encrypted electronic private key corresponding to the block chain based decentralized distribution system;
(b) electronically creating an electronic public key and an electronic block chain address from the created encrypted electronic private key;
(c) electronically sending, from the back end computing system to the front end computing system, a session ID and a randomly generated challenge phrase;
(d) electronically signing, through the user interface of the front end application, the randomly generated challenge phrase using an elliptic curve digital signature;
(e) electronically sending, to the back end computing system, the elliptic curve digitally created signature, session ID, and the electronic block chain address created from the encrypted electronic private key; and
(f) electronically authenticating the session ID when the elliptic curve digitally created signature corresponds to the electronic block chain address created from the encrypted electronic private key.

2. A method for enabling a user to securely create a project with digital rights for a block chain based decentralized distribution system having a front end computing system, the front end computing system including a front end processor, a display, a user interface, and front end memory, the decentralized distribution system having a back end computing system communicatively connected to the front end computing system, the back end computing system including a back end processor and back end memory, comprising:
(a) electronically creating, using the user interface of the front end computing system, a project by assigning values to token parameters;
(b) electronically choosing, using the user interface of the front end computing system, a method of payment;
(c) electronically sending, to the front end computing system, a tx hash if the chosen payment method is fiat currency;
(d) electronically sending, to the front end computing system, a transaction receipt if the chosen payment method is digital currency;
(e) electronically sending, to the back end computing system, the tx hash or the transaction receipt with the values assigned to the token parameters of the created project;
(f) electronically adding the created project into a job queue and returning a job id to the front end computing system when the back end computing system verifies payment via the received tx hash or the received transaction receipt;
(g) electronically creating and deploying, at the back end computing system, a token smart contract and a rights/reward smart contract, the token smart contract having an address and the rights/reward smart contract having an address;
(h) electronically registering, at the back end computing system, the address of the token smart contract and the address of the rights/reward smart contract; and
(i) electronically registering, at the back end computing system, a transaction in a registry smart contract to register the token smart contract and the rights/reward smart contract to an address of the user, thereby creating an immutable record of the existence of the created token smart contract and the created rights/reward smart contract on a block chain.

3. The method as claimed in claim 2, further comprising:
(j) creating electronic tokens related to the created project, using the back end computing system, based upon the assigned values to token parameters.

4. The method as claimed in claim 3, wherein the created electronic tokens are programmed with a specific set of functions and utility.

5. The method as claimed in claim 3, wherein the created electronic tokens are programmed with a specific monetary value.

6. An authentication system for a block chain based decentralized distribution system comprising:
a front end computing system; and
a back end computing system communicatively connected to said front end computing system;
said front end computing system including a front end processor, a display, a user interface, and front end memory;
said back end computing system including a back end processor and back end memory;
said front end computing system electronically creating, using the user interface of said front end computing system, an encrypted electronic private key corresponding to the block chain based decentralized distribution system;
said front end computing system electronically creating an electronic public key and an electronic block chain address from the created encrypted electronic private key;
said back end computing system electronically sending, to said front end computing system, a session ID and a randomly generated challenge phrase;
said front end computing system electronically signing, through the user interface of said front end application, the randomly generated challenge phrase using an elliptic curve digital signature;
said front end computing system electronically sending, to said back end computing system, the elliptic curve digitally created signature, session ID, and the electronic block chain address created from the encrypted electronic private key; and
said back end computing system electronically authenticating the session ID when the elliptic curve digitally created signature corresponds to the electronic block chain address created from the encrypted electronic private key.

7. A system for enabling a user to securely create a project with digital rights for a block chain based decentralized distribution system comprising:
a front end computing system; and
a back end computing system communicatively connected to said front end computing system;
said front end computing system including a front end processor, a display, a user interface, and front end memory;
said back end computing system including a back end processor and back end memory;
said front end computing system electronically creating, using the user interface of said front end computing system, a project by assigning values to token parameters;
said front end computing system electronically choosing, using the user interface of said front end computing system, a method of payment;
said back end computing system electronically sending, to said front end computing system, a tx hash if the chosen payment method is fiat currency;
said back end computing system electronically sending, to said front end computing system, a transaction receipt if the chosen payment method is digital currency;
said front end computing system electronically sending, to said back end computing system, the tx hash or the transaction receipt with the values assigned to the token parameters of the created project;
said back end computing system electronically adding the created project into a job queue and returning a job id to said front end computing system when said back end computing system verifies payment via the received tx hash or the received transaction receipt;
said back end computing system electronically creating and deploying a token smart contract and a rights/reward smart contract, the token smart contract having an address and the rights/reward smart contract having an address;
said back end computing system electronically registering the address of the token smart contract and the address of the rights/reward smart contract; and
said back end computing system electronically registering a transaction in a registry smart contract to register the token smart contract and the rights/reward smart contract to an address of the user, thereby creating an immutable record of the existence of the created token smart contract and the created rights/reward smart contract on a block chain.

8. A system for enabling a user to securely launch a created token on a block chain based decentralized distribution system comprising:
a front end computing system; and
a back end computing system communicatively connected to said front end computing system;
said front end computing system including a front end processor, a display, a user interface, and front end memory;
said back end computing system including a back end processor and back end memory;
said front end computing system electronically choosing, using the user interface of said front end computing system, a number of token to be made available and assigning parameters for the number of tokens;
said front end computing system electronically sending, to said back end computing system, the number of token to be made available and the assigned parameters for the number of tokens;
said back end computing system electronically creating a token launch contract; and
said back end computing system electronically registering the token launch contract on a block chain.

9. The system as claimed in claim 8, wherein said back end computing system electronically creates electronic tokens related to the created project based upon the assigned values to token parameters.

10. The system as claimed in claim 9, wherein the created electronic tokens are programmed with a specific set of functions and utility.

11. The system as claimed in claim 9, wherein the created electronic tokens are programmed with a specific monetary value.
